(19) United States
(12) Patent Application Publication
(10) Pub. No.: US 2009/0031547 A1
(43) Pub. Date: Feb. 5, 2009

(54) METHOD OF MANUFACTURING A COMPUTING APPARATUS

(76) Inventors: Christian L. Belady, McKinney, TX (US); Paul L. Perez, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/831,153

(22) Filed: Jul. 31, 2007

(51) Int. Cl. B23P 11/00; B25B 27/14

(52) U.S. Cl. 29/431; 29/281.1

(57) ABSTRACT

A method of manufacturing a computing apparatus may include providing a plurality of computer components for the computing apparatus. The computing apparatus and the plurality of computer components can be transported from an origin to a geographically distant destination with a transport vehicle. Manufacture of the computing apparatus is substantially completed during the transporting of the computing apparatus.

### BACKGROUND

In many computing applications, particularly in a corporate setting, it may be desirable to add a large amount of computing capacity in a short period of time. Historically, an internal or external customer (hereafter “customer”) of a computer manufacturer, wishing to add computing capacity, has been obliged to construct a data center structure in a new building or repurpose an existing building structure for data center use; obtain and install the requisite computer components to outfit the data center; provide power, cooling, networking, and other infrastructure functions to the data center; test the data center; and interface the data center with existing computing resources.

This upgrade process is expensive and time-consuming for any customer, and is particularly unsuitable for temporary or traveling computing applications, such as those serving the computing needs of a major sporting event or concert tour. Moreover, a customer (particularly a large customer) may wish to avoid the costly and relatively trivial efforts needed for researching, designing, purchasing components for, and assembling each data center facility and would be willing to purchase a prefabricated “plug and play” computer capacity solution.

In response to these commercial considerations, computer manufacturers are starting to provide modular or pod-style computing apparatus. These computing apparatus may contain all of the computer components needed to provide data center and related infrastructure services within a transportable enclosure. When a customer places an order for a computing apparatus, the computer manufacturer manufactures the computing apparatus according to the customer order and transports the computing apparatus to the customer site. The customer simply connects the delivered computing apparatus to electrical (usually substation) power and to a fat data pipe, and optionally to an external cooling source if required by the computing apparatus.

While this modular computing apparatus system works well for many customers, there are still delays which may be costly for customers seeking the addition of computing capacity within a short time frame. Because the computing apparatus require many expensive computer components and because many different configurations of the computing apparatus are possible, the computer manufacturer is unlikely to maintain an inventory of completed computing apparatus. Therefore, a specific computing apparatus will probably not be manufactured past a very basic assembly level until a customer order specifying the desired finished characteristics is received. In addition, the computing apparatus may be manufactured using “just in time” processes which require a relatively close geographic proximity to suppliers of the computer components used in the computing apparatus. For example, the computer component suppliers could be located in Asia; when the customer site is in the United States, transportation of the computing apparatus—or computer components thereof—could be quite time-consuming and detrimental to providing computing apparatus to the customer in a prompt manner.

### BRIEF DESCRIPTION OF THE DRAWINGS

FIG. 1 is a schematic side view of a computing apparatus for manufacture with an embodiment of the invention.

FIG. 2 is a flowchart of a method according to a first embodiment of the invention.

FIG. 3 is a flowchart of a method according to a second embodiment of the invention.

FIG. 4 is a flow diagram of a method according to yet another embodiment of the invention.

### DETAILED DESCRIPTION

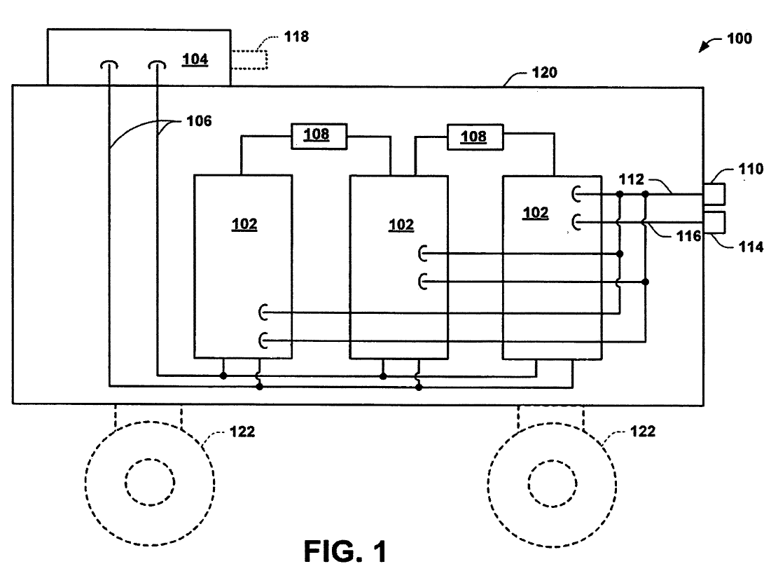

FIG. 1 depicts a schematic side view of an example computing apparatus 100 that can be manufactured. The computing apparatus 100 may include a plurality of server computers 102, a cooling system 104 having cooling lines 106 connected to each of the server computers, a plurality of networking elements 108 connected to the server computers, a data interface 110 connected to each of the server computers by a data line 112, and a power interface 114 connected to each of the server computers by a power line 116. The data interface 110 is operative to transmit data to and from an outside data source (not shown) for use by the computing apparatus 100. The power interface 114 is operative to accept power from an outside power source (not shown) for use by the computing apparatus. Optionally, as shown in dashed line, a cooling interface 118 may be provided for accepting external cooling resources.

Additionally or alternatively, the computing apparatus 100 could include cabinets, racks, data storage, physical storage, cable trays, telephone interfaces, power backups, cooling backups, or any other desired data center features. The computing apparatus 100 could also or instead include any desired adapters, converters, generators, or other elements operative to transform an input item into a form usable by the computing apparatus 100 and/or to transform an output item into a form usable by an outside agent (not shown). Collectively, the server computers 102, cooling system 104, cooling lines 106, networking elements 108, data interface 110, data lines 112, power interface 114, power lines 116, cooling interface 118, cabinets, racks, data storage, physical storage, cable trays, telephone interfaces, power backups, cooling backups, adapters, converters, generators, and other element or combination of elements which might be used to provide computing capacity and related services as desired will hereafter be referenced as “computer components”. A particular computing apparatus 100 could include any one or combination of computer components, in a temporary or permanent installation, along with any other desired items or structures.

Along with the computer components, the computing apparatus 100 includes a transportable enclosure 120. The transportable enclosure 120 could be of any suitable type, and optionally includes a transport mechanism 122 such as the schematic wheels shown in FIG. 1. The transportable enclosure 120 could be self-powered or reliant upon another structure for motive power (e.g., the transportable enclosure 120 could be a trailer pulled by a truck [not shown], a hull or sea vessel pulled by a ship for marine applications). Some nonlimiting examples of suitable computing apparatus 100, and elements thereof, are provided in commonly assigned U.S. patent application Ser. No. [FILL IN SERIAL NO.; Attorney Docket No. 200603275-1], entitled “Scalable Computing Apparatus” and filed Apr. 25, 2007; and commonly assigned U.S. patent application Ser. No. [FILL IN SERIAL NO.; Attorney Docket No. 200700550-1], entitled “Modular Data Center Operations” and filed [FILL IN FILING DATE]. One of ordinary skill in the art can readily provide a desired combination of transportable enclosure 120 and at least one computer component to include a computing apparatus 100 suitable for a particular computing application.

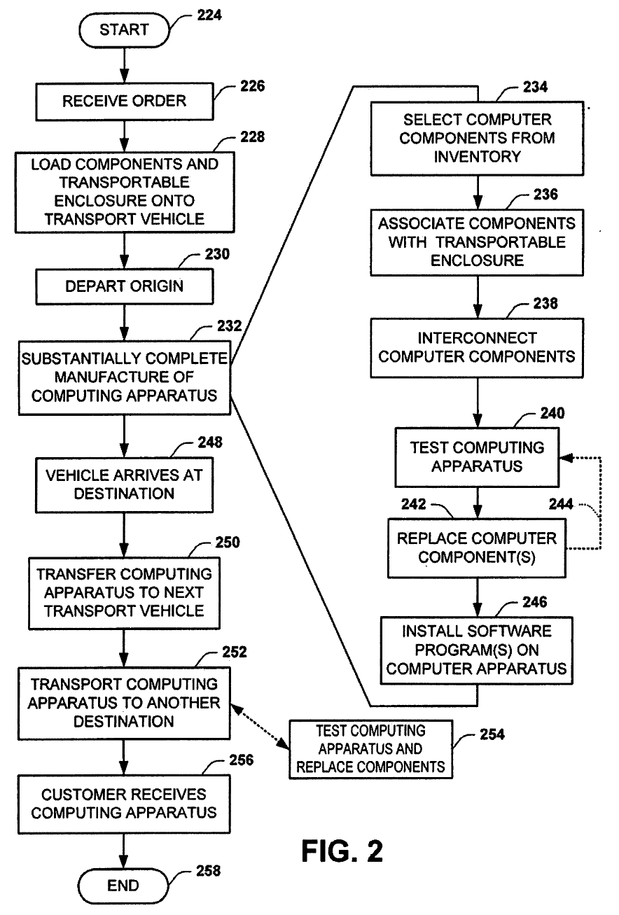

FIG. 2 is a flowchart depicting an example method of manufacturing a computing apparatus 100. The method begins at block 224 and proceeds to block 226. At 226, a computer manufacturer receives an order from an internal or external customer for a computing apparatus 100. The order may be received by any communication method and may be automatically generated in response to an outside stimulus, such as, but not limited to, a predetermined time schedule. The order may have previously been modified or otherwise processed by the computer manufacturer. Regardless of any preprocessing and of the method of conveyance, the order informs the receiving party (presumed herein to be a logistics center) of the elements needed to manufacture the computing apparatus 100. This “pick list” may be explicitly laid out in the order or may require reference to an external reference (not shown) such as a parts catalog.

Regardless of the nature or format of the order, once the order has been received, the method proceeds to block 228. At 228, a plurality of computer components and at least one transportable enclosure 120 are provided and loaded onto a transport vehicle. The components should be sufficient to complete the order. At this stage, the transportable enclosure 120 may be an empty shell, or one or more computer component may already be associated with the transportable enclosure. For example, if some or all computing apparatus 100 include a power interface 114, a supply of transportable enclosures 114 with a power interface already installed could be provided by the computer manufacturer before the method starts at start block 224.

The transport vehicle is operative to carry at least one computing apparatus 100, or elements thereof, in any stage of manufacturing, for a relatively large distance. Namely, the transport vehicle carries the computing apparatus 100 from an origin to a geographically distant destination. “Geographically distant” is used herein to indicate a separation on the order of one or more miles, and is generally presumed to encompass a journey between two or more factories, warehouses, shipping yards, retailers, distributors, customer sites, or the like. “Geographically distant” will normally not include a distance within a single manufacturing facility, but instead indicates a distance between substantially separate locations in one country, or between two or more countries or even continents. As described herein, the transport vehicle will be presumed to be carrying the computing apparatus 100 many hundreds of miles, on a voyage lasting one or more days.

The transport vehicle may be any suitable land, sea, or air vehicle, or combination thereof, such as, but not limited to, a truck, ship, train, airplane, spacecraft, or the like. The transport vehicle may carry any number of computing apparatus 100, or elements thereof, in any suitable manner, enclosed or exposed, and the computing apparatus 100 could be moved to different locations on the transport vehicle during transportation, as desired.

Returning to block 228, at least one unassembled or partially assembled transportable enclosure 120 and a plurality of computer components are loaded onto the transport vehicle. The computer components could be placed inside the transportable enclosure 120 before or during the loading, or could be carried in a temporary or permanent storage/warehouse area of the transport vehicle, which may be spaced apart from the transportable enclosure. Optionally, a relatively large inventory of computer components could be provided on the transport vehicle, including more computer components than are needed for a single computing apparatus 100. When such an inventory is provided, the plurality of computer components intended for use with a specific computing apparatus 100 may be selected, before or during transportation, as a subset of the inventory as desired and/or responsive to a specific customer order. When there is no larger inventory provided, however, the plurality of computer components could merely be provided and loaded on the transport vehicle responsive to a customer order. One of ordinary skill in the art could readily determine how many of each type of computer component is expected to be used, based upon factors such as historical and/or real-time order fulfillment and/or component failure data.

As a further example, and also at block 228, at least one completely manufactured computing apparatus 100 could be loaded onto the transport vehicle for transport between the origin and destination along with at least one unassembled or partially assembled computing apparatus. Once the transport vehicle has been loaded as desired with computing apparatus 100 in any stages of manufacture, transportable enclosures 120, computer components, and any other goods to be transported concurrently with the computing apparatus, the transport vehicle departs the origin at block 230, headed for the geographically distant destination. The transport vehicle may make one or more intermediate stops before reaching the destination, which is defined for each computing apparatus 100 as the location at which that computing apparatus is removed from the transport vehicle. A single transport vehicle may visit a plurality of origins and destinations during a single voyage, with each origin and destination defined with reference to one or more of a plurality of computing apparatus 100 carried by the transport vehicle.

Once the transport vehicle has departed the origin, the method proceeds to block 232, wherein the manufacturing of the computing apparatus is substantially completed during transport to the geographically distant destination. Due to the multiple operations which may be carried out during onboard manufacturing, the block 232 has been subdivided, as shown in FIG. 2, into block 234 through block 246.

In block 234, a plurality of computer components associated with a particular computing apparatus 100 may be selected from an inventory of computer components as previously described, if not already done. The plurality of computer components, whether selected from an inventory on the transport vehicle or provided as a group in block 228, are then used to substantially complete manufacture of the computing apparatus 100 in blocks 236 and 238.

At 236, the plurality of computer components are selectively automatically or manually associated with the transportable enclosure 120. At this stage of manufacture, the computing apparatus 100 may be partially manufactured or may be wholly unmanufactured (i.e., could be just an aggregation of unarranged elements). To selectively associate the plurality of computer components with the transportable enclosure 120, one or more technicians, optionally using one or more hand and/or power tools, installs one or more computer components in or on (hereafter referenced as “within”) the transportable enclosure 120. The nature of the installation or association will depend upon the specific computer component in question and how that specific computer component relates to the transportable enclosure 120. For example, and as shown in FIG. 1, a cooling system 104 may be secured to an outer surface of the transportable enclosure 120, while a data or power interface 110 or 114 may extend through from an outer to an inner surface of the transportable enclosure. Associating or installing a specific computer component may require one or more intermediate computer components. For example, a server subassembly may be secured to a server rack to produce a server computer 102 which is then installed in the transportable enclosure 120. At this stage of manufacturing, the plurality of computer components are merely installed within the transportable enclosure 120.

The method of manufacturing next proceeds to 238, at which the plurality of computer components are selectively interconnected to form the computing apparatus 100. The interconnection may be performed by one or more technicians, optionally using one or more hand and/or power tools, and any desired cords, cables, wires, optical fibers, additional computer components, or the like may be used to aid in the interconnection. At 238, it is contemplated that data and/or power lines 112 and 116 may be run between any desired combinations of computer components to substantially complete manufacturing of the computing apparatus 100. For example, each computer component needing electrical power to run could be interconnected with a power interface 114, with any desired number and type of intervening computer components therebetween. Additionally or alternatively, other types of connections (e.g., data buses or communication links) can be made at 238.

At 238, manufacturing of the computing apparatus 100 can be considered to be substantially completed, thus finishing the tasks associated with block 232. However, the blocks 240 through 246, any or all of which could be performed in any order within the scope of block 232, will now be described.

By way of further example, at 240, all or part of the computing apparatus 100 may be tested. This testing could include a mere confirmation of electrical power or data signal flow between two computer components (e.g., a check to be sure data or power lines 112 or 116 are securely seated/connected), or even just confirmation of the physical tightness of interconnections. The testing could also or instead include trials with standard benchmarking software, or even the installation and test running of the actual working software which the computing apparatus 100 is eventually intended to run on an ongoing/production basis. Different testing could be conducted for different elements of the computing apparatus 100 (e.g., temperature testing of the cooling system 104 and voltage testing of the power interface 114). The testing can be performed within the transport vehicle. Additionally or alternatively, test data generated during such testing can be communicated to one or more remote site (e.g., manufacturer site, customer site or third party site), such as through a wireless communication link.

It is contemplated that customer personnel could carry out at least a portion of the testing, as well as any other manufacturing tasks, as desired. These customer personnel could board the transport vehicle at the origin or at any other point before their assigned tasks are carried out. When working with the computing apparatus 100 in this manner, the customer personnel will become familiar with the structure, layout, specifications, capacities, and other properties and characteristics of the computing apparatus, which may be useful in the ongoing operation and maintenance of the computing apparatus by the customer. Additionally, having customer personnel test the computing apparatus 100 during transport will help to maintain confidentiality or secrecy regarding customer-proprietary software applications which may be used during testing without requiring that confidential portion of the testing to occur after the computing apparatus has reached the customer site. Any software used to test the computing apparatus 100 can be removed or uninstalled as desired upon completion of testing.

Particularly when testing is done at 240, at least one originally installed computer component of the computing apparatus 100 could be replaced with another computer component at block 242. The replacement computer component could be taken from elsewhere in the computing apparatus 100 or could be supplied from an inventory of computer components carried by the transport vehicle. The replacement computer component could be selected and used to replace a defective original computer component. Alternately, the replacement computer component could replace a correctly operating original computer component which is no longer desired in the computing apparatus 100. For example, testing at block 240 could indicate that the original computer component does not have the specifications needed to perform as desired in the finished computing apparatus 100, or the customer order could be changed during manufacture of the computing apparatus so that the original computer component no longer fulfills the order.

As is indicated by the return loop 244 in FIG. 2, blocks 240 and 242 may be repeated in alternating sequence until the results of testing are satisfactory to the testing personnel. Once testing and replacement of computer components has been completed as desired, the method proceeds to 246, wherein at least one software program is installed on at least one computer component. It is contemplated that software installed at 246 is the actual working software which that portion of the computing apparatus 100 is intended to run, at least initially, for the customer's computing application.

When at least the portions of the method at blocks 236 and 238 have been completed as desired, manufacturing of the computing apparatus 100 is considered to have been substantially completed. The transport vehicle then arrives at the destination at 248. This destination may be a customer site or may be a factory, warehouse, shipping yard, retailer, distributor, or the like.

Optionally, and normally when the destination at which the transport vehicle arrives at 248 is not a final destination for the computing apparatus, the method can proceed to 250, wherein one or more computing apparatus 100 may be transferred at that location to a second transport vehicle, which may be of any suitable type. The second transport vehicle then transports the computing apparatus 100 (e.g., still within the transportable enclosure) from the destination to another geographically distant destination, as shown at 252. Blocks 250 and 252 may be repeated as many times as desired to transport the computing apparatus 100 to the final destination, such as the customer site.

The computer manufacturer and/or customer may select or carry out the portions of the method between block 234 through block 246 responsive to the length of time that the transport vehicle will take to travel between the origin and the geographically distant destination. For example, fewer of these procedures may be carried out on a relatively short journey than on a longer journey, so that the transport vehicle does not have to sit idle after arrival at the destination just to allow completion of the scheduled procedures. If the journey between the origin and the geographically distant destination is relatively short and one or more additional transport vehicle is used to transport the computing apparatus to another destination as in block 252, one of the procedures from block 234 through block 246 could be carried out during that second transport phase. For example, and as shown at 254, at least one computer component could be tested, and optionally replaced as desired, during transport of the computing apparatus 100 from the first destination to another destination.

Once the computing apparatus 100 has been transported to as many destinations, by as many transport vehicles, as desired, the customer receives the computing apparatus at the customer site, at 256. After customer receipt of the ordered computing apparatus 100 (the process of which could include additional testing or verification), the method of FIG. 2 concludes at end block 258.

When a computing apparatus 100 is manufactured using the method of FIG. 2, the customer will receive the computing apparatus more promptly than if the computing apparatus 100 were made using a known method of being manufactured at the origin and then being shipped to the customer. Manufacturing during transport therefore will assist the manufacturer in providing stock or custom computing apparatus 100 to a customer in a timely manner.

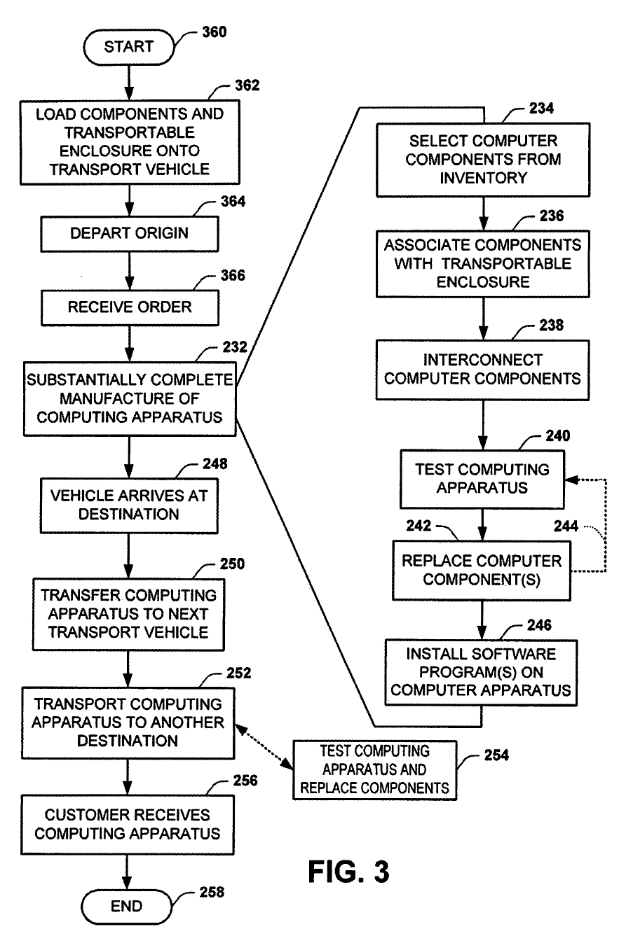

FIG. 3 is a flowchart depicting an example method of manufacturing a computing apparatus 100. While the method depicted in FIG. 3 appears to be substantially similar to the method shown and described above with reference to FIG. 2, one of ordinary skill in the art can readily understand that various configurations could have components, arrangements, formats, aspects, and the like different from those shown. For sake of brevity, a description of common elements and their operation similar to those in the previously described to the first embodiment will not be repeated with respect to the example method depicted in the second embodiment.

The method of FIG. 3 begins at start block 360. Next, the method proceeds to block 362, at which a plurality of computer components and at least one transportable enclosure 120 are loaded onto the transport vehicle. At least one transportable enclosure 120 could be completely unmanufactured or could be partially manufactured. After loading, the transport vehicle departs the origin at 364.

A main distinction between the first and second examples of FIGS. 2 and 3 becomes apparent at 366, wherein the customer order is received during transport of the computing apparatus 100. From 366, the method proceeds substantially similarly to the method of the first example described above with respect to FIG. 2, above. For sake of consistency, the same reference numbers are used to describe the same portions of the method in FIG. 3, as previously introduced in FIG. 2.

Since the customer order is received after the transport vehicle has left the origin, a variety of computer components must be loaded on the transport vehicle in the first action step 362, to allow substantial completion of manufacturing of a computing apparatus 100 having any of a number of possible configurations. However, the customer will probably receive a computing apparatus 100 manufactured according to the method of the second embodiment even more quickly than receiving a computing apparatus manufactured according to the method of the first embodiment. Unless the customer orders a highly customized computing apparatus 100 or inventory space aboard the transport vehicle is in short supply, the method of manufacture of the second embodiment should therefore result in extremely quick delivery of the completely manufactured computing apparatus to the customer.

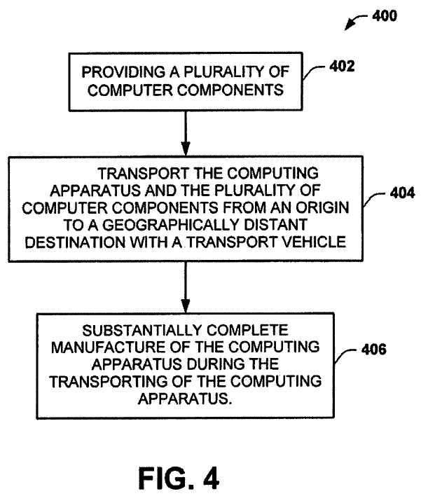

FIG. 4 depicts an example of a method 400 of manufacturing a computing apparatus. The method includes providing a plurality of computer components for the computing apparatus, shown at 402. The computing apparatus and the plurality of computer components are transported from an origin to a geographically distant destination with a transport vehicle, shown at 404. The manufacture of the computing apparatus is substantially completed during the transporting of the computing apparatus, as shown at 406.

While aspects of the present invention have been particularly shown and described with reference to the preferred embodiment above, it will be understood by those of ordinary skill in the art that various additional embodiments may be contemplated without departing from the spirit and scope of the present invention. For example, any of the depicted and described blocks and/or method steps could be carried out in any suitable order and are not limited to performance in the order shown. Any of the depicted and described blocks and/or method steps could be repeated (e.g., a computer component could be uninstalled temporarily during interconnection and then reinstalled). A robot or other automated assistance device could be used to associate, install, or interconnect one or more computer components. The customer could carry out additional association, installation, interconnection, and/or testing procedures upon receipt of the computing apparatus 100 at the final destination. Receipt of the customer order as described could be by any division or section of the computer manufacturer and need not be by the logistics center. While the computing apparatus 100 is substantially manufactured during transport between the origin and geographically distant destination, minor manufacturing tasks may still be carried out after the computing apparatus has reached the destination. A device or method incorporating any of these features should be understood to fall under the scope of the present invention as determined based upon the claims below and any equivalents thereof.

What have been described above are examples and embodiments of the invention. It is, of course, not possible to describe every conceivable combination of components or methodologies for purposes of describing the invention, but one of ordinary skill in the art will recognize that many further combinations and permutations of the present invention are possible. Accordingly, the invention is intended to embrace all such alterations, modifications and variations that fall within the scope of the appended claims. In the claims, unless otherwise indicated, the article “a” is to refer to “one or more than one”.

What is claimed is:

1. A method of manufacturing a computing apparatus, the method comprising:
providing a plurality of computer components for the computing apparatus;
transporting the computing apparatus and the plurality of computer components from an origin to a geographically distant destination with a transport vehicle; and
substantially completing manufacture of the computing apparatus during the transporting of the computing apparatus.

2. The method of claim 1, wherein the computing apparatus includes a transportable enclosure for housing the plurality of computer components, the method comprising:
selectively installing the plurality of computer components within the transportable enclosure;
selectively interconnecting the plurality of computer components to form the computing apparatus; and
wherein the selectively installing and selectively interconnecting occur during the transporting.

3. The method of claim 2, further comprising:
providing an inventory of computer components on the transport vehicle for the computing apparatus; and
selecting at least a portion of the plurality of computer components from the inventory of computer components.

4. The method of claim 3, wherein the substantially completing manufacture further comprises using the selected at least a portion of the plurality of computer components.

5. The method of claim 3, wherein the selecting of the plurality of computer components occurs responsive to a customer order.

6. The method of claim 1, wherein the providing of the plurality of computer components occurs responsive to a customer order.

7. The method of claim 1, wherein the substantially completing manufacture occurs responsive to a customer order that is received during the transporting of the computing apparatus.

8. The method of claim 1, wherein the computing apparatus is a first computing apparatus and the method further comprises transporting at least one completely manufactured second computing apparatus from the origin to the geographically distant destination with the transport vehicle.

9. The method of claim 1, further comprising testing the computing apparatus during the transporting.

10. The method of claim 9, wherein the substantially completing manufacture includes replacing at least one computer component of the computing apparatus with another computer component responsive to the testing.

11. The method of claim 1, wherein the substantially completing manufacture further comprises installing a software program on at least one computer component.

12. The method of claim 1, wherein the transport vehicle is a first transport vehicle, the method further comprising:
transferring the computing apparatus to a second transport vehicle at the geographically distant destination; and
transporting the computing apparatus from the geographically distant destination to a second geographically distant destination.

13. The method of claim 12, further comprising testing at least one computer component during the transporting the computing apparatus to the second geographically distant destination.

14. A method of manufacturing a computing apparatus, the method comprising:
partially manufacturing the computing apparatus before the computing apparatus is loaded onto a transport vehicle;
carrying a plurality of computer components for the computing apparatus on the transport vehicle;
transporting the computing apparatus and the plurality of computer components from an origin to a geographically distant destination with the transport vehicle; and
substantially completing manufacture of the computing apparatus during the transporting of the computing apparatus.

15. The method of claim 14, wherein the computing apparatus includes a transportable enclosure for housing the plurality of computer components, the method comprising:
selectively installing the plurality of computer components within the transportable enclosure;
selectively interconnecting the plurality of computer components to form the computing apparatus; and
wherein at least a portion of the selectively installing and selectively interconnecting occurs during the transporting.

16. The method of claim 14, wherein the substantially completing manufacture occurs responsive to a customer order that is received during the transporting.

17. The method of claim 14, further comprising testing the computing apparatus during the transporting.

18. The method of claim 14, wherein the substantially completing manufacture further comprises installing a software program on at least one computer component.

19. A manufacturing system for a computing apparatus, the manufacturing system comprising:
means for providing a transportable enclosure for a plurality of computer components;
means for associating the plurality of computer components with the transportable enclosure to form the computing apparatus;
means for interconnecting at least a portion of the plurality of computer components that form the computing apparatus; and
means for transporting the computing apparatus from an origin to a geographically distant destination, wherein at least one of the means for associating and the means for interconnecting is carried by the means for transporting.

20. The manufacturing system of claim 19, including means for testing at least a portion of the plurality of computer components, wherein the means for testing is carried by the means for transporting.
